(19) United States
(12) Patent Application Publication
(10) Pub. No.: US 2007/0110511 A1
(43) Pub. Date: May 17, 2007

(54) Coupling mechanism for connecting board-type shelf to vertical post of a sectional rack

(75) Inventor: Henry Chen, Taipei (TW)

Correspondence Address: BRUCE H. TROXELL, SUITE 1404, 5205 LEESBURG PIKE, FALLS CHURCH, VA, 22041, US

(73) Assignee: Protrend Co., Ltd.

(21) Appl. No.: 11/271,894

(22) Filed: Nov. 14, 2005

(51) Int. Cl. F16L 41/00

(52) U.S. Cl. 403/230

(57) ABSTRACT

A coupling mechanism includes a locating unit fitted in a groove preformed at each lower corner of a board-type shelf; a tightness control element located in the locating unit to couple to an engaging head of a hanger hooked to a vertical post, which engaging head is moved into the tightness control element via a window provided at a bottom of the locating unit; and an adjusting unit including a slide movably supported on two oblique guide slots on the tightness control element and an adjusting screw mounted on the locating unit to thread through the slide. When the adjusting screw is turned, the slide is moved up or down along the oblique slots to loosen or tighten the tightness control element from or against the engaging head of the hanger, enabling easy removal or connection of the shelf from or to the vertical post.

### FIELD OF THE INVENTION

The present invention relates to a coupling mechanism for connecting a board-type shelf to a vertical post of a sectional rack, and more particularly to a coupling mechanism that is invisibly mounted to each lower corner of a board-type shelf to connect the shelf to a post of a sectional rack, giving the whole rack a high quality appearance.

### BACKGROUND OF THE INVENTION

A sectional rack has become indispensable in many houses, offices, and open-shelf stores because it can be easily assembled, disassembled, transported, and stored.

There are many types of sectional racks that could be assembled and erected without using any fastening elements, such as the sectional rack using bamboo-like vertical posts. U.S. Pat. Nos. 5,676,263; 5,303,645; 5,174,676; 4,991,725; 4,799,818; 4,595,107; 4,546,887; and 4,763,799 all disclose structures in connection with sectional racks using the bamboo-like vertical posts.

Most of the shelves for the sectional racks using the bamboo-like vertical posts are made of metal wires or flat boards. The shelf made of metal wires has rather weak structural strength, and includes a plurality of through holes, via which articles positioned on the shelf might very possibly drop. The sectional rack using the metal wire shelves is less beautiful in its appearance, too. The board-type shelf has a flat and smooth top surface for stably holding articles thereon, and has beautiful appearance. To assemble the board-type shelf to the vertical posts, conic sleeves must be provided to all corners of the shelf. The conic sleeves spoil the integrity of the shelf and make the whole rack looked ugly and unable to meet the general consumers' requirement.

### SUMMARY OF THE INVENTION

A primary object of the present invention is to provide a coupling mechanism for connecting a board-type shelf to a vertical post of a sectional rack without protruding any connecting elements thereof from the shelf, so that the whole rack presents a beautiful and high quality appearance.

The coupling mechanism of the present invention includes a coupling device that is fitted in a groove preformed at each lower corner of the shelf to flush with a bottom surface of the shelf, enabling the shelf before being connected to the post to have completely flat and smooth top, bottom, and side surfaces to facilitate convenient storage and transport of the shelf.

In addition to the coupling device, the coupling mechanism of the present invention further includes a hanger that has a front engaging head located in the coupling device and a hooked rear end hung on connecting holes on the post. By mounting the coupling device at each lower corner of the shelf to couple to the hanger on a corresponding vertical post, the shelf can be connected to and supported on the vertical posts to provide a rack.

The coupling device includes a tightness control element, in which the engaging head of the hanger is located; and an adjusting unit adapted to change a position of the tightness control element relative to the hanger, so that the tightness control element may be loosened from or tightened against the engaging head of the hanger to facilitate easy removal or connection of the shelf from or to the vertical post.

The adjusting unit includes a slide located in the tightness control element, and an adjusting screw threaded through the slide. When the adjusting screw is turned, the slide is moved up or down to bring the tightness control element to loosen from or tighten against the engaging head of the hanger.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a fragmentary bottom perspective view showing a board-type shelf connected to a vertical post of a rack using the coupling mechanism of the present invention;

FIG. 2 is an exploded view of FIG. 1;

FIG. 3 is a bottom perspective view showing a coupling device of the coupling mechanism of the present invention before being mounted to a bottom side of the board-type shelf;

FIG. 4 is a complete bottom perspective view showing a board-type shelf is connected at four lower corners to four vertical posts using the coupling mechanism of the present invention;

FIG. 5 is an exploded bottom perspective view of the coupling device included in the coupling mechanism of the present invention;

FIG. 6 is a cross-sectional view of FIG. 1 showing the coupling device of the present invention mounted to the lower corner of the board-type shelf is in a loosened position relative to a hanger hooked on the vertical post; and

FIG. 7 is similar to FIG. 6 but showing the coupling device of the present invention mounted to the lower corner of the board-type shelf is in a tightened position relative to the hanger on the vertical post.

### DETAILED DESCRIPTION OF THE PREFERRED EMBODIMENTS

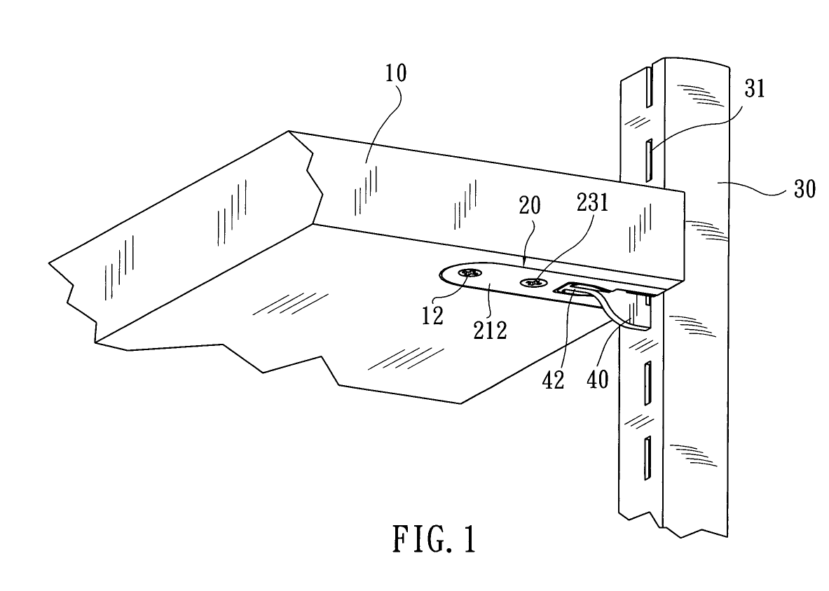

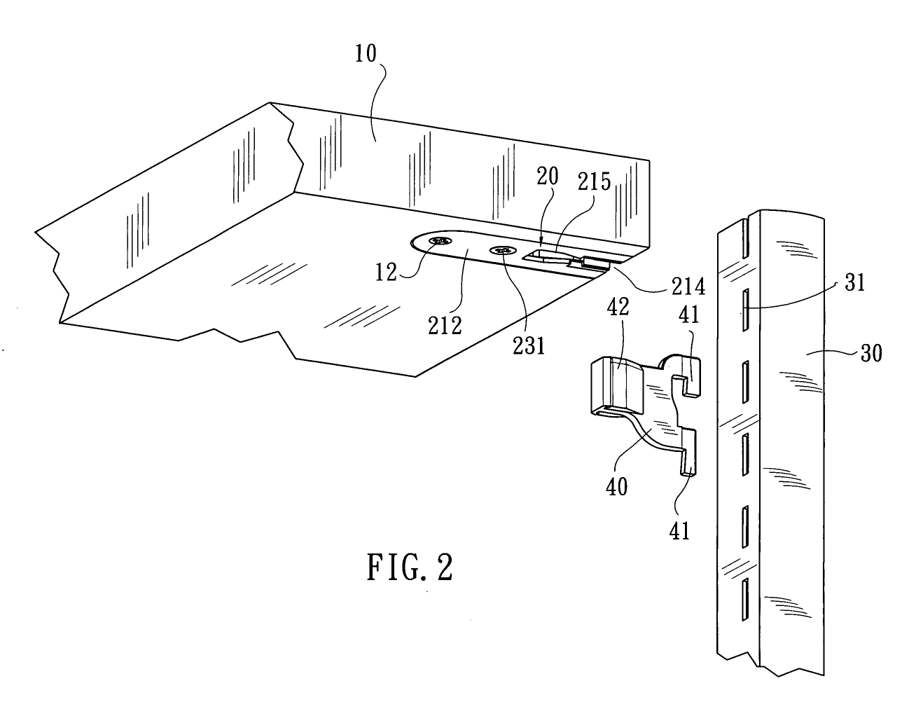

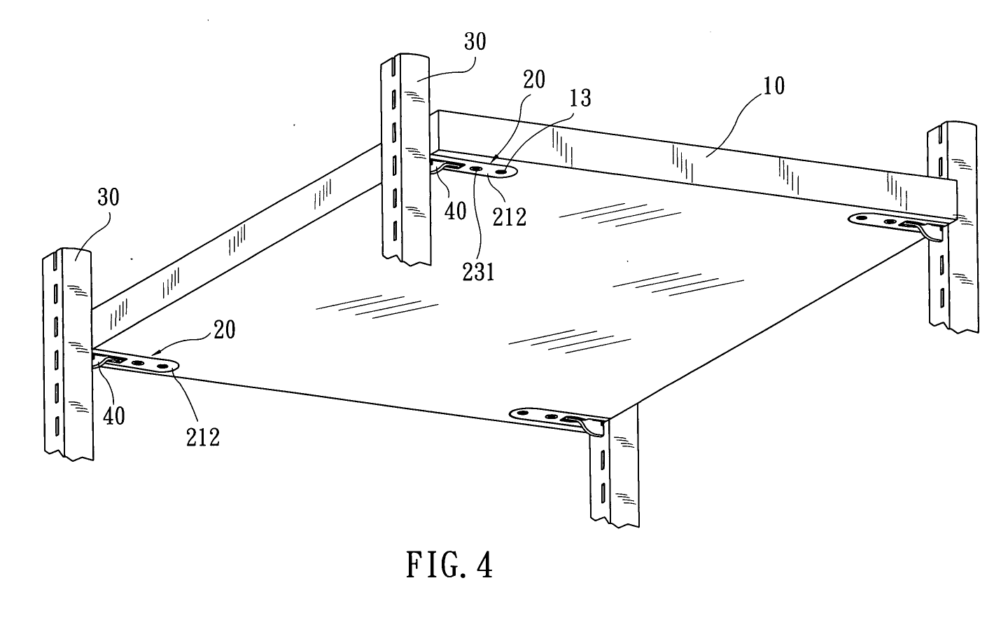

Please refer to FIGS. 1 and 4 that are fragmentary and complete assembled bottom perspective views, respectively, showing a board-type shelf 10 is connected at each lower corner to a vertical post 30 of a sectional rack using a coupling mechanism of the present invention; and to FIG. 2 that is an exploded view of FIG. 1. As can be clearly seen from FIG. 2, the coupling mechanism includes a coupling device 20 mounted at each lower corner of the shelf 10, and a hanger 40.

The vertical post 30 is symmetrically provided on two opposite sides with a row of connecting holes 31 each. The hanger 40 is hung onto the vertical post 30 by extending two vertically spaced hooks 41 provided at a rear end of the hanger 40 into two vertically adjacent connecting holes 31 on the post 30. An engaging head 42 is provided at a front end of the hanger 40.

The board-type shelf 10 is provided at each lower corner with one coupling device 20, which is adapted to couple to the engaging head 42 of the hanger 40 hung on the vertical post 30.

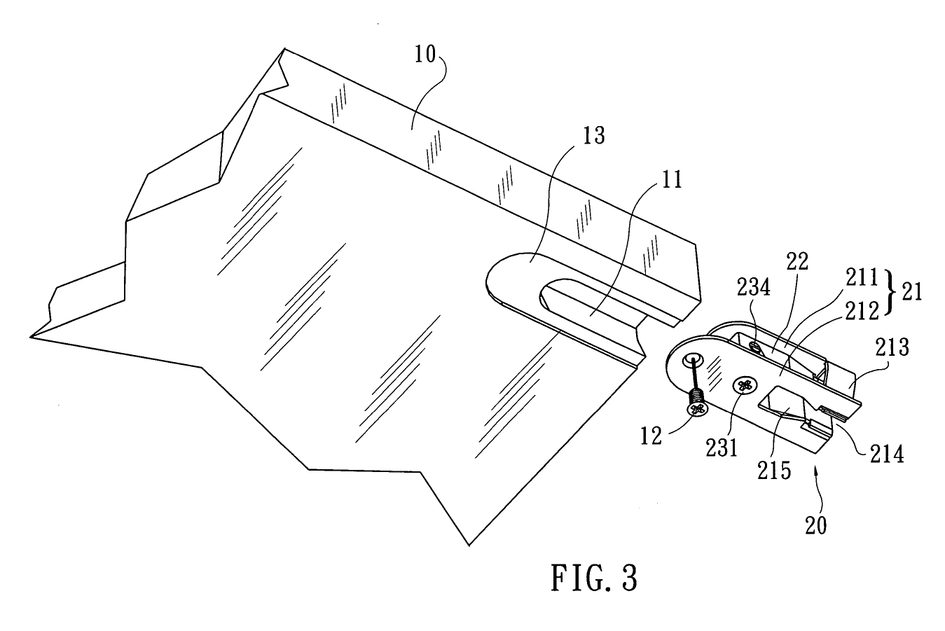

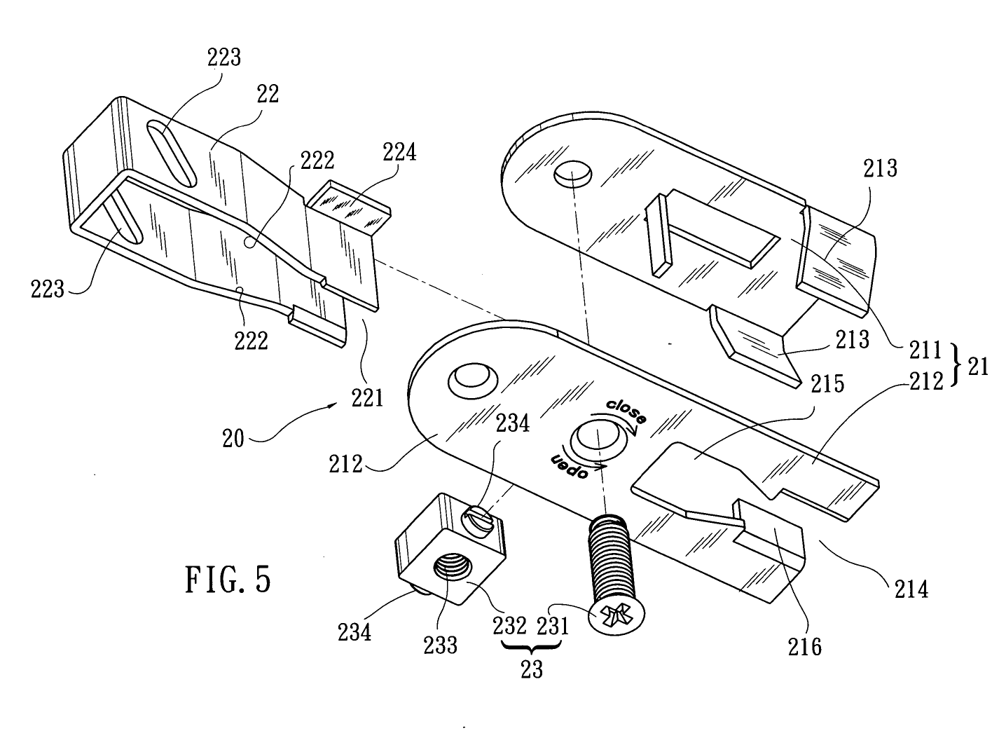

Please refer to FIG. 3 that is a bottom perspective view showing the coupling device 20 of the present invention before being mounted to the lower corner of the board-type shelf 10, and to FIG. 5 that is an exploded bottom perspective view of the coupling device 20. As shown, the coupling device 20 includes a locating unit 21, a tightness control element 22, and an adjusting unit 23.

As can be seen from FIG. 3, the locating unit 21 is firmly fitted in a groove 11 preformed at the lower corner of the board-type shelf 10 using a screw 12, and includes a base plate 211, which is fitted in the groove 11, and a cover plate 212 for closing an open lower side of the groove 11. Please refer to FIG. 5. In the illustrated embodiment of the present invention, the base plate 211 is provided at two opposite lateral sides of an outer end facing toward the post 30 with two downward extended and slightly inward bent tabs 213. It is noted the groove 11 preformed at the bottom side of the shelf 10 is a dovetail groove having a cross section corresponding to that of the base plate 211 at the two tabs 213 (see FIG. 3). When the base plate 211 is inserted into the groove 11, the two tabs 213 fitly bear against an inner wall surface of the groove 11, allowing the base plate 211 to stably and tightly locate in the groove 11. The cover plate 212 has an overall width and an overall length slightly larger than those of the base plate 211, and can be fitly set in a shallow recessed area 13 formed at the bottom of the shelf 10 around the groove 11. The cover plate 212 is locked to the shallow recessed area 13 by the screw 12. The base plate 211 and the cover plate 212 of the locating unit 21 together define at the outer end a side opening 214 oriented to one side of the shelf 10 facing toward the post 30, and at a central area between them a hollow space for receiving the tightness control element 22 therein. The cover plate 212 is provided near the outer end with a window 215 to communicate with the side opening 214.

The tightness control element 22 is a lying U-shaped member formed from a flat plate to include a side opening 221 at an outer end thereof. Two sidewalls of the lying U-shaped tightness control element 22 are substantially parallelly extended from a closed top at an inner end of the element 22 by a predetermined distance and then tapered toward the side opening 221, so that two inclined inner wall surfaces 222 are formed immediately behind the side opening 221. Two downward and outward inclined oblique guide slots 223 are symmetrically formed on the parallel portion of the two sidewalls of the control element 22 near the closed top thereof.

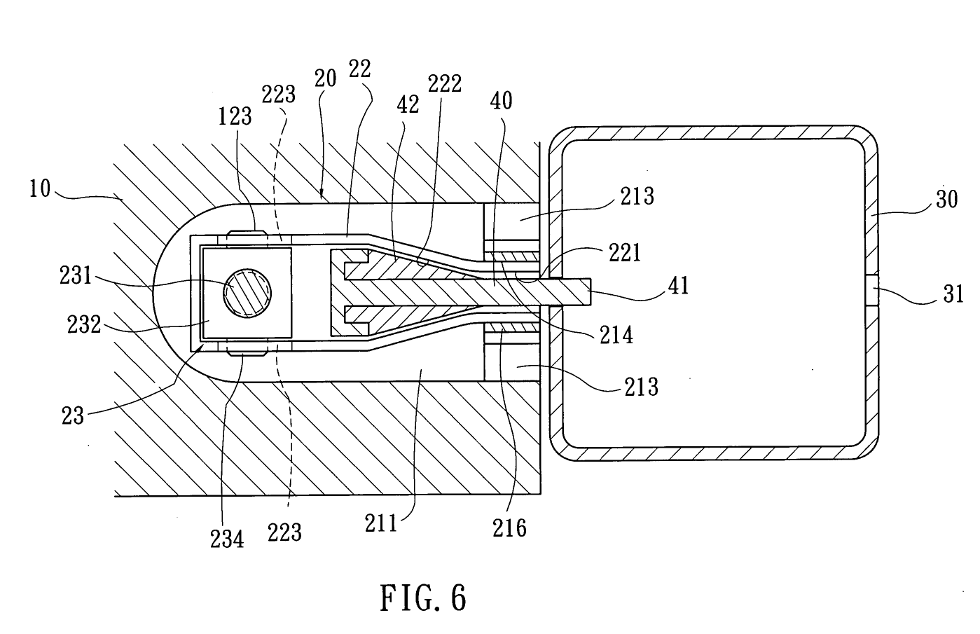

Please refer to FIG. 6 that is a cross-sectional view of FIG. 1 showing the coupling device 20 mounted to the lower corner of the board-type shelf 10 is coupled to the engaging head 42 at the front end of the hanger 40, and the two hooks 41 at the rear end of the hanger 40 are connected to the connecting holes 31 on the post 30. The engaging head 42 of the hanger 40 has a cross section tapered from the front end toward the rear end of the hanger 40, and is shaped and dimensioned corresponding to a space in an outer part of the tightness control element 22 immediately behind the side opening 221. The coupling device 20 is connected to the hanger 40 by moving the engaging head 42 of the hanger 40 into the hollow central space of the tightness control element 22 via the window 215 on the cover plate 212 of the locating unit 21.

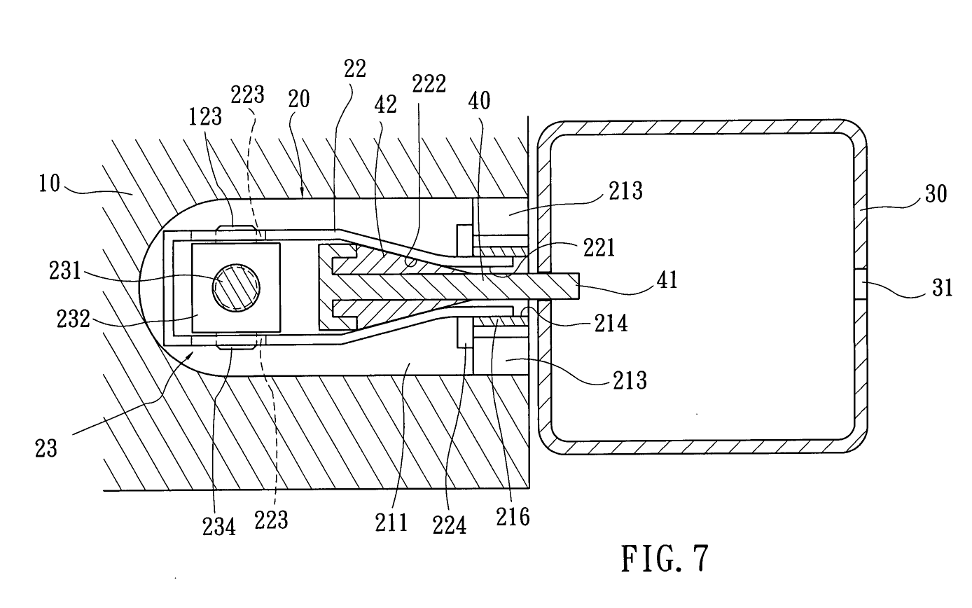

Please refer back to FIGS. 3 and 5. The adjusting unit 23 includes an adjusting screw 231 mounted on the locating unit, and a slide 232. The slide 232 includes a centered, vertically extended, and internally threaded hole 233 and two opposite, horizontally outward extended shafts 234. The slide 232 is located between the two parallel sidewalls of the tightness control element 22 with the two opposite horizontal shafts 234 separately movably seated in the two oblique guide slots 223 on the element 22. The adjusting screw 231 is upward threaded through the cover plate 212, the internally threaded vertical hole 233 on the slide 232, and the base plate 211 to be pivotally turnable about an axis of the slide 232. When the adjusting screw 231 is turned, the slide 232 is caused to move up or down along the two oblique guide slots 223 on the tightness control element 22 and thereby brings the latter to move toward the inner end or the outer end of the groove 11. In the illustrated embodiment of the present invention, when the adjusting screw 231 is turned clockwise, the tightness control element 22 is brought to move toward the inner end of the groove 11 and therefore presses the two inclined inner wall surfaces 222 against the engaging head 42 of the hanger 40 hung on the post 30, as shown in FIG. 7. At this point, the tightness control element 22 tightly pulls the engaging head 42 of the hanger 40 for the whole coupling device 20 to firmly couple to the hanger 40 and for the board-type shelf 10 to stably connect to the post 30. And, when the adjusting screw 231 is turned counterclockwise, the tightness control element 22 is brought to move toward the outer end of the groove 11, as shown in FIG. 6. At this point, the two inclined inner wall surfaces 222 of the tightness control element 22 no longer tightly press against the engaging head 42 of the hanger 40, allowing the board-type shelf 10 to be easily removed from the post 30.

For easy operation, words with arrows showing different operational directions, such as “close” and “open”, may be marked on the cover plate 212, as shown in FIG. 5. The two horizontal shafts 234 provided at two opposite sides of the slide 232 may be two screws symmetrically threaded into the two opposite sides of the slide 232. Meanwhile, to facilitate easy mounting of the slide 232 in the tightness control element 22, the length of the two horizontal shafts 234 projected from the two opposite sides of the slide 232 may adjusted by changing the depth by which the two screws are threaded into the slide 232.

The tightness control element 22 is located in the central hollow space of the locating unit 21 with the side opening 221 located in the side opening 214 at the outer end of the locating unit 21, such that the side opening 221 of the tightness control element 22 is restrained from expanding due to a fixed openness of the side opening 214 of the locating unit 21. After the engaging head 42 of the hanger 40 is moved into the tightness control element 22 via the window 215 on the cover plate 212 of the locating unit 21, the adjusting screw 231 may be turned in a correct direction to allow connecting of the board-type shelf 10 to the post 30.

Please refer back to FIG. 5. The cover plate 212 of the locating unit 21 is provided at two lateral sides of the window 215 near the side opening 214 with an upward extended tab 216 each. When the cover plate 212 is closed to a lower side of the base plate 211, the two upward tabs 216 are adapted to fitly bear against the inner side of the two downward tabs 213 of the base plate 211, as shown in FIG. 6, and a distance between the two upward tabs 216 defines the openness of the side opening 214 of the locating unit 21. Moreover, the tightness control element 22 is provided at a top of each sidewall adjacent to the side opening 221 with a sideward projected wing portion 224, which serves as a means to prevent the tightness control element 22 from moving sideward in the locating unit 21.

As can be seen from FIG. 4, the coupling device 20 is mounted to each lower corner of the board-type shelf 10 to couple to the engaging head 42 of the hanger 40 hung on the post 30. When the adjusting screws 231 of all the coupling devices 20 below one shelf 10 are sequentially turned clockwise, all the tightness control elements 22 in the coupling devices 20 are caused to tightly press against the engaging heads 42 of the hangers 40, allowing the board-type shelf 10 to be firmly and stably connected to and supported on the posts 30.

It is noted the coupling device 20 of the present invention is set in the groove 11 formed at each lower corner of the board-type shelf 10 to flush with a bottom surface of the shelf 10. In this manner, the shelf 10 does not have any member protruded from its top, bottom, and all side surfaces, and would have a volume as small as possible to occupy a minimum space for storage and transport. Moreover, the board-type shelf 10 connected to the posts 30 advantageously shields the hangers 40, giving the rack fully assembled from the posts 30 and the shelves 10 a high quality appearance without any exposed connecting members.

What is claimed is:

1. A coupling mechanism for connecting board-type shelf to vertical post of a sectional rack, comprising a coupling device and a hanger;
said coupling device including:
a locating unit being firmly fitted in a groove preformed at each lower corner of said board-type shelf; said locating unit defining at an outer end facing toward said vertical post a first side opening, at a central area a hollow space, and at a bottom near the outer end with a window to communicate with said first side opening;
a tightness control element being located in said central hollow space in said locating unit; said tightness control element being a lying U-shaped member formed from a flat plate to include a second side opening at an outer end thereof, which second side opening is located in said first side opening on said locating unit, and two sidewalls substantially parallelly extended from a closed top at an inner end thereof by a predetermined distance and then tapered toward said second side opening, so that two inclined inner wall surfaces are formed immediately behind said second side opening; and
an adjusting unit mounted on said locating unit and said tightness control element for adjusting a position of said tightness control element in said locating unit relative to said groove;
said locating unit being coupled to said vertical post via said hanger hung on two vertically spaced connecting holes on said vertical post; said hanger being connected at a front engaging head to said locating unit, and at two vertically spaced rear hooks to said connecting holes on said vertical post; said engaging head of said hanger having a rearward tapered cross section, and being shaped and dimensioned corresponding to a space in an outer part of said tightness control element behind said second side opening; and said engaging head being moved into the space at the outer part of said tightness control element via said window formed at the bottom of said locating unit; and
said adjusting unit being operable to either move said tightness control element to a first position, in which said tightness control element is closer to an inner end of said groove to press said two inclined inner wall surfaces against said engaging head of said hanger hung on said vertical post to thereby tightly pull said engaging head of said hanger for said whole coupling device to firmly couple to said hanger, allowing said board-type shelf to stably connect to said vertical post, or a second position, in which said tightness control element is closer to an outer end of said groove to release said two inclined inner wall surfaces from tightly pressing against said engaging head of said hanger, allowing said board-type shelf to be easily removed from said vertical post.

2. The coupling mechanism for connecting board-type shelf to vertical post of a sectional rack as claimed in claim 1, wherein said locating unit of said coupling device includes a base plate, which is fitted in said groove preformed at the lower corner of said board-type shelf, and a cover plate for closing an open lower side of said groove.

3. The coupling mechanism for connecting board-type shelf to vertical post of a sectional rack as claimed in claim 1, wherein said second side opening on said tightness control element located in said first side opening on said locating unit is restrained from expanding due to a fixed openness of said first side opening.

4. The coupling mechanism for connecting board-type shelf to vertical post of a sectional rack as claimed in claim 1, wherein said adjusting unit includes an adjusting screw mounted on said locating unit, and a slide located between the parallel portion of said two sidewalls of said tightness control element; said slide including a centered, vertically extended, and internally threaded hole, through which said adjusting screw mounted on said locating unit is threaded to be turnable about an axis of said vertical threaded hole, such that said slide is moved up or down along said adjusting screw when said adjusting screw is turned.

5. The coupling mechanism for connecting board-type shelf to vertical post of a sectional rack as claimed in claim 4, wherein said slide is provided at two opposite sides with two horizontally outward extended shafts, which are separately movably seated in two downward and outward extended oblique guide slots formed on said parallel sidewalls of said tightness control element; whereby when said adjusting screw is turned, said slide is caused to move up or down along said two oblique guide slots to thereby bring said tightness control element toward the inner end or the outer end of said groove, respectively.
